(19) United States
(12) Patent Application Publication
(10) Pub. No.: US 2012/0146255 A1
(43) Pub. Date: Jun. 14, 2012

(54) Process For Producing Pellets Comprising At Least One Water-Soluble Component

(75) Inventors: Angelika Maschke, Mannheim (DE); Karl Kolter, Limburgerhof (DE); Norbert Güntherberg, Speyer (DE)

(73) Assignee: BASF SE, Ludwigshafen (DE)

(21) Appl. No.: 13/315,740

(22) Filed: Dec. 9, 2011

Related U.S. Application Data
(60) Provisional application No. 61/421,634, filed on Dec. 10, 2010.

(30) Foreign Application Priority Data
Dec. 10, 2010 (EP) EP 10194454.4

(51) Int. Cl. B29C 47/88

(52) U.S. Cl. 264/210.1

(57) ABSTRACT

Methods of producing and using pellets based on at least one thermoplastically processible polymer are described. The pellets comprise at least one water-soluble component. The process comprises melt-extruding the pellet and shaping the pellet in a coolant, which is a non-solvent for the polymer, where the kinematic viscosity of the coolant is <20 mm²/s, measured at 40° C.

### CROSS-REFERENCE TO RELATED APPLICATIONS

This application claims priority to U.S. Provisional Application No. 61/421,634, filed Dec. 10, 2010 and to European Patent Application No. 10194454.4, filed Dec. 10, 2010, the entire disclosures of which are hereby incorporated herein in their entirety.

### TECHNICAL FIELD

The present invention relates to a process for producing pellets based on thermoplastically processible polymers, where the pellets comprise at least one water-soluble component, via melt extrusion and pelletization in a coolant, and also to corresponding pellets and their use.

### BACKGROUND

In order to simplify the handling of polymers during the processing steps that follow the production, polymers are frequently converted to pellets which are granular and flowable and, therefore easy to convey. This is achieved by forcing the molten polymer through a pelletizing die and then cooling it in a water bath. The resultant solidified polymer strand is chopped by a rotary cutter to give pellets which are more or less cylindrical and a few mm in length, and once these have been dried to remove water adhering to their surface they are packaged and/or introduced to further processes. Another variant frequently used is known as underwater pelletization, in which the polymer melt is forced through a die plate, and on the side of this, within a water-flooded cutter chamber, that faces away from the material a rotating knife, mostly consisting of multiple cutters, separates the polymer melt passing through the die plate into small portions which are transported away by the cooling water flowing through the chamber and during this process freeze to give spherical or lenticular pellets. Said processes are used for polymers which are not soluble in water.

Corresponding apparatuses and processes are described by way of example in DE-A 2646309, U.S. Pat. No. 4,264,553, or U.S. Pat. No. 5,143,673. The hot plastic melt here is conveyed from an extruder via an orifice plate directly into a liquid coolant, in this case water. The plastic strands that emerge are comminuted by a cutting apparatus, attached to the orifice plate, to give pellets, and are transported away by the water, which is mostly conducted in a circuit, and are isolated and dried. This liquid-cooled process can produce very small particle sizes uniformly and continuously, and on an industrial scale, extending down to the submillimeter range. Because coolants are used that have high heat capacity and high heat-transfer capability, an example being water, the pellets are cooled rapidly while they are still plastic, and do not cake, and can be produced with very uniform shape and size.

Pelletization of water-soluble or water-swellable polymers by this route is problematic. The polymer can dissolve entirely or to some extent during the cooling process in the water, or the strand or the pellets can undergo surface solvation and cake. This can result in stoppage of the process.

One process commonly used for pelletizing water-soluble polymers is cooling in air or inert gas. The polymer strand emerging from the extruder is laid on a belt for the cooling process and is then pelletized. Teflon belts or chain belts, or cooled steel belts (Sandvik belts) are suitable for this process, and run concomitantly with the drawn-off strand, at the same speed. Experience has shown that the capacity of process variants of this type is much smaller than that of the water-cooled processes, and the products produced by this route are therefore expensive.

Another variant is die-face cutting, where the hot polymer melt is chopped by rotating knives on exit from the extruder and cooled by a stream of air. However, this process is not suitable for every polymer and has restricted throughput capacity because of the low cooling capacity of air.

Formulations which comprise active ingredients, for example comprising vitamins as active ingredient, are used to keep humans and animals healthy, being administered in parallel with food consumption or added in the form of food additive. Many of the formulations produced involving vitamins, vitaminoids, or other food supplements are required for animal nutrition. The feeds used in that sector are administered in the form of ground product with an average particle size of from 0.3 to 0.5 mm, and feed additives should therefore have approximately the same size and uniformity, if demixing is to be avoided. Uniform grain size is also particularly important in the production of pellets for pharmaceutical products, since dissolution behavior, and thus bioavailability, depends on grain size. The production processes used hitherto for food supplements, feed additives, or pellets for pharmaceutical products are complicated and expensive processes for grinding, granulation, and spraying.

There are well-known preparations which comprise active ingredients and which are produced by melt extrusion. The extrusion of melts of water-soluble polymers, for example copolymers of vinylpyrrolidone, these comprising active ingredients, is known by way of example from EP-A 240904 and EP-A 240906. EP-A 240 906 also describes the melt extrusion process for mixtures which comprise active ingredients and which comprise copolymers of methyl methacrylate and acrylic acid, copolymers of vinyl acetate and crotonic acid, and also ethylene/vinyl acetate copolymers. The shaping process uses injection molding or extrusion with a subsequent forming process while the strand remains plastic, e.g. via die-face cutting to give pellets, or a forming process that produces tablets. The shaping process takes place in air in all of the examples mentioned. The resultant pharmaceutical forms are generally water-soluble.

By way of example, DE-A 19536387 also describes the melt extrusion and shaping of products comprising vitamins. Water-soluble, thermoplastic hydroxypropylcelluloses are used as matrix. In the examples, melts made from vitamin C or β-carotene together with hydroxypropylcellulose are compressed by a shaping calender to give tablets. Die-face cutting of the water-soluble matrix to give pellets is also mentioned.

Although water-soluble formulations of this type can be produced by melt extrusion followed by pelletization in air, a disadvantage is that, because of poor heat dissipation, this method is frequently incapable of achieving the required (small) particle size and uniformity, and is frequently difficult to realize on an industrial scale.

U.S. Pat. No. 6,632,389 discloses the production of pellets comprising biologically active substances by underwater pelletization or pelletization under hydrocarbons. A detailed description is provided of appropriate control of the pH value in the coolant in order to achieve underwater pelletization of polymers having pH-dependent solubility. Pelletization in coolants such as mineral oils or vegetable oils is mentioned only in very general terms.

However, hydrocarbons have been found to be unsuitable in principle as coolant. Accordingly, there is an ongoing need in the art for improved methods of pelletization.

### SUMMARY

Embodiments of the invention are directed to processes for producing pellets based on at least one thermoplastically processible polymer. The pellets comprise at least one water-soluble component. The process comprises melt-extruding the pellet and shaping the pellet in a coolant. The coolant is a non-solvent for the polymer, and has a kinematic viscosity <20 mm²/s, measured at 40° C.

In some embodiments, the kinematic viscosity of the coolant is in the range of about 10 to about 19 mm²/s, measured at 40° C. In detailed embodiment, the kinematic viscosity of the coolant is in the range of about 11 to about 18 mm²/s, measured at 40° C. In specific embodiments, the kinematic viscosity of the coolant is in the range of about 12 to about 17 mm²/s, measured at 40° C.

In one or more embodiments, the coolant comprises a hydrocarbon. In detailed embodiments, the coolant comprises a white oil.

In some embodiments, the coolant is temperature-controlled. In specific embodiments, the coolant has a temperature of at least 50° C. below a temperature of the extruded melt.

In one or more embodiments, the pellets are isolated from the coolant by centrifuging. In detailed embodiments, the pellets are isolated from the coolant by filtering.

The melt extrusion process of some embodiments is carried out at melt temperatures in the range of about 50 to about 300° C.

In some embodiments, the water-soluble component comprises a water-soluble thermoplastically processible polymer. In detailed embodiments, the water-soluble component comprises a water-soluble biologically active substance. In specific embodiments, the water-soluble component comprises homo- or copolymers of N-vinyllactams. In certain embodiments, the water-soluble component comprises graft copolymers based on polyethers. In certain specific embodiments, the graft copolymer comprise polyether units as graft base and polyvinyl alcohol units as side chains. The graft copolymers of one or more embodiments comprise polyether units as a graft base and side chains obtained from N-vinylcaprolactam and N-vinyl acetate. In some embodiments, the water-soluble component comprises polyvinyl acetate.

The pellet of one or more embodiments comprises a coprocessed mixture comprising polyvinyl acetate and polyvinylpyrrolidone.

Additional embodiments of the invention are directed to methods for producing a dosage form comprising using the pellet of claim 1 and a biologically active substance.

### BRIEF DESCRIPTION OF THE DRAWINGS

FIG. 1 shows a graph of the percent of drug release as a function of time for samples prepared in accordance with one or more embodiments of the invention.

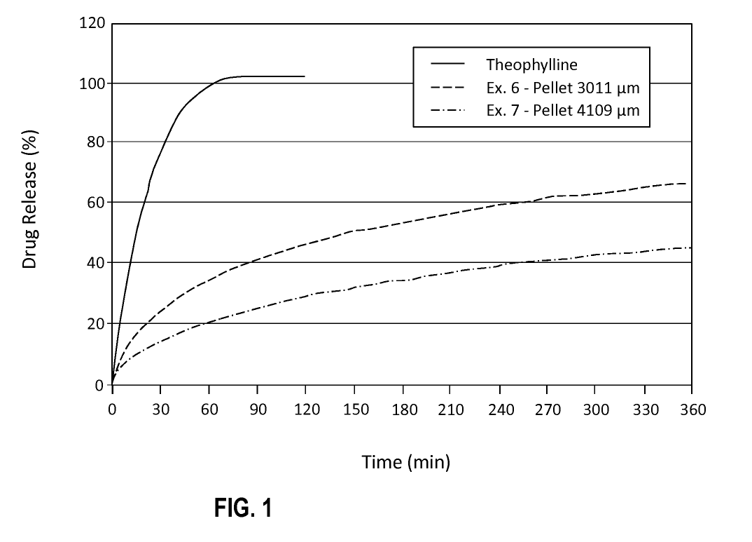

### DETAILED DESCRIPTION

The inventors have discovered an improved process for the pelletization of thermoplastically processible water-soluble or water-swellable polymers in a coolant.

Accordingly, a process has been discovered for producing pellets based on at least one thermoplastically processible polymer, where the pellets comprise at least one water-soluble component, the process comprising melt-extruding the pellet and shaping in a coolant, which is a non-solvent for the polymer, where the viscosity of the coolant is <20 mm²/s, measured at 40° C.

Embodiments of the invention are suitable for producing pellets in which at least one biologically active substance (active ingredient) is present in homogeneous dispersion in a matrix of the polymer. The active ingredient here can be dissolved (solid solution) or dispersed within the polymer. The term “dispersed” means that the active ingredient is present in the form of molecular dispersion (<1 nm), colloidal dispersion (from 1 to 500 nm), coarse dispersion (<500 nm), microscopic coarse/fine dispersion (from 500 nm to 100 μm), or macroscopic coarse dispersion (>100 μm), where the numbers given between parentheses relate to the average particle sizes of the active-ingredient phase.

Molecular-dispersion systems are also termed “solid solutions”. Solid solutions are X-ray amorphous, and this means that less than 5% by weight of crystalline fractions can be found in the X-ray diffractogram. The term “solid solutions” is familiar to the person skilled in the art (see Chiou and Riegelman, J. Pharm. Sci. 60, 1281-1302 (1971)).

In one or more embodiments, the water-soluble component is the biologically active substance.

In some embodiments, the water-soluble component is a water-soluble, thermoplastically processible polymer.

In some embodiments, the pellets comprise a water-soluble biologically active substance and at least one water-soluble thermoplastically processible polymer.

Detailed embodiments comprise pellets which comprise, as matrix polymers, mixtures of at least one water-soluble polymer with polymers that are insoluble or sparingly soluble in water.

A process has been discovered which can produce pellets in which biologically active substances are present in homogeneous dispersion in a matrix based on at least one thermoplastically processible polymer, where the pellets are obtained by homogeneous mixing of the starting materials in the melt and subsequent extrusion and shaping.

Suitable polymers include, but are not limited to, those which are per se thermoplastically processible or which are thermoplastically processible in a mixture with other polymers and/or with other auxiliaries.

Polymers that can be used as matrix polymers include, for example, water-soluble polymers, polymers having pH-dependent solubility, sparingly soluble polymers, or insoluble polymers. Water-soluble thermoplastically processible polymers used can also be polymers which have an LOST (Lower Critical Solution Temperature).

The term “water-soluble” means that from 1 to 30 g of water per g of polymer are required to produce a solution of the polymer in water at 20° C. The term “sparingly soluble in water” covers substances which have low solubility, are sparingly soluble, or else are practically insoluble, and means that from 30 g to 1000 g of water per g of polymer are required to produce a solution of polymer in water at 20° C. In the case of substances that are “practically insoluble,” at least 10,000 g of water are required per g of substance. The substances termed water-soluble polymers are water-soluble at a wide range of pH values.

As used in this specification and the appended claims, the term “sparingly soluble” is used interchangeably with “sparingly soluble in water”. The list of sparingly soluble polymers includes but are not limited to, polymers which are not soluble across the entire pH range, but instead exhibit pH-dependent solubility.

Examples of suitable water-soluble polymers include, but are not limited to, water-soluble homo- and copolymers of N-vinylpyrrolidone. By way of example, homopolymers having Fikentscher K values of from 10 to 100, in particular K12, K15, K30, K 60, K90, are suitable. In detailed embodiments, the copolymers of N-vinylpyrrolidone are copolymers with vinyl acetate, for example, those having a ratio by weight of N-vinylpyrrolidone (NVP) to vinyl acetate (VAc) in the range of about 60:40 to about 80:20, and in particular the copolymer termed copovidone in the European and US Pharmacopoeias with an NVP/VAc ratio of 60:40 by weight.

Other suitable water-soluble polymers include, but are not limited to, polyvinyl alcohols, where these are usually obtained in the form of homopolymers via hydrolysis of polyvinyl acetate.

Graft polymers based on polyethers as graft base are likewise suitable. These graft copolymers can be obtained via, for example, free-radical polymerization of vinyl monomers in the presence of polyethers. Examples of suitable vinyl monomers include, but are not limited to, N-vinyllactam monomers, such as N-vinylpyrrolidone or N-vinylcaprolactam, or a mixture thereof. Other suitable vinyl monomers include, but are not limited to, vinyl ethers or vinyl esters, in particular vinyl acetate. In the case of graft copolymers that are obtained with the use of vinyl acetate, the ester groups can also be present to some extent or entirely in hydrolyzed form. Other suitable comonomers are acrylates or methacrylates. Specific materials include, but are not limited to, polyvinyl alcohol-polyethylene glycol graft copolymers, or graft copolymers which can be obtained through free-radical polymerization of a mixture made of polyethylene glycol, N-vinylcaprolactam, and/or vinyl acetate. Graft polymers of this type are available commercially as Kollicoat® IR or Soluplus®, BASF.

Other water-soluble polymers that can be used include, but are not limited to, polyalkylene glycols, e.g. polyethylene glycols, ethylene glycol-propylene glycol block copolymers, hydroxyalkylated celluloses, e.g. hydroxypropylmethylcellulose, hydroxypropylcellulose, hydroxyethylcellulose, polysaccharides, e.g. carrageenans, pectins, xanthans, or alginates.

In some embodiments, polymers sparingly soluble in water are either neutral polymers that are sparingly soluble (retard polymers), anionic polymers that are sparingly soluble (polymers resistant to gastric fluid), or basic polymers that are sparingly soluble.

Neutral polymers that are sparingly soluble are those polymers which, across a wide range of pH values and are sparingly soluble in water or are only swellable in water. The pharmaceutical composition generally comprises only one water-insoluble polymer. However, it is also optionally possible that two or more water-insoluble polymers are present alongside one another or in a mixture. Examples of suitable polymers that are sparingly soluble include, but are not limited to, methacrylate copolymers that are neutral or that are in essence neutral. These can be composed of at least 95% by weight, or at least 98% by weight, or at least 99% by weight, or up to about 100% by weight, of (meth)acrylate monomers which have neutral moieties, in detailed embodiments, C1-C4-alkyl moieties, and which have been polymerized by a free-radical route.

Examples of suitable (meth)acrylate monomers having neutral moieties include, but are not limited to, methyl methacrylate, ethyl methacrylate, butyl methacrylate, methyl acrylate, ethyl acrylate, butyl acrylate. Detailed embodiments include methyl methacrylate, ethyl acrylate, and methyl acrylate. The materials can comprise small amounts of methacrylate monomers having anionic moieties, e.g. acrylic acid and/or methacrylic acid, where these amounts are less than about 5% by weight, or at most about 2% by weight, or at most about 1% by weight or in the range of about 0.05 to about 1% by weight. Examples of suitable materials include, but are not limited to, neutral or almost neutral (meth)acrylate copolymers made of from about 20 to about 40% by weight of ethyl acrylate, from about 60 to about 80% by weight of methyl methacrylate, and from about 0 to less than about 5% by weight, or from about 0 to about 2% by weight, or from about 0.05 to about 1% by weight, of (Eudragit® NE). Eudragit NE is a copolymer made of 30% by weight of ethyl acrylate and 70% by weight of methyl methacrylate.

Examples of other suitable (meth)acrylate copolymers that are sparingly soluble include, but are not limited to, polymers which have swellability or solubility that is independent of pH, where these are suitable for coatings on pharmaceutical products.

The polymer that is sparingly soluble can be, for example, a polymer made of from 98 to 85% by weight of C1-C4-alkyl esters of acrylic or methacrylic acid and from 2 to 15% by weight of (meth)acrylate monomers having a quaternary ammonium group, or can be a mixture of a plurality of polymers within said class of substances.

The polymer that is sparingly soluble can also be, for example, a polymer made of from 97 to more than 93% by weight of C1-C4-alkyl esters of acrylic or methacrylic acid and from 3 to less than 7% by weight of (meth)acrylate monomers having a quaternary ammonium group (Eudragit® RS). In detailed embodiments, C1-C4-alkyl esters of acrylic or methacrylic acid are methyl acrylate, ethyl acrylate, butyl acrylate, butyl methacrylate, and methyl methacrylate may be used. Particular embodiments use 2-trimethylammoniumethyl methacrylate chloride as (meth)acrylate monomer having quaternary amino groups. An example of a suitable copolymer comprises about 65% by weight of methyl methacrylate, about 30% by weight of ethyl acrylate, and about 5% by weight of 2-trimethylammoniumethyl methacrylate chloride (Eudragit RS).

The polymer that is sparingly soluble can be a polymer made of from about 93 to about 88% by weight of C1-C4-alkyl esters of acrylic or methacrylic acid and from about 7 to about 12% by weight of (meth)acrylate monomers having a quaternary ammonium group (Eudragit RL). A specific suitable copolymer comprises by way of example about 60% by weight of methyl methacrylate, about 30% by weight of ethyl acrylate, and about 10% by weight of 2-trimethylammoniumethyl methacrylate chloride (Eudragit® RL).

In specific embodiments, the water-insoluble polymer is a mixture of Eudragit RS and Eudragit RL polymers in a ratio in the range of about 20:1 to about 1:20.

Mixtures made of EUDRAGIT RS and Eudragit RL by way of example in a ratio of from 20:1 to 1:20 parts by weight may be particularly suitable.

The pharmaceutical composition can also comprise a polyvinyl acetate as polymer that is sparingly soluble. Examples of suitable polyvinyl acetates include, but are not limited to, the homopolymers of vinyl acetate. Other suitable materials include, but are not limited to polyvinyl acetate copolymers that are sparingly soluble, examples including being water-insoluble copolymers made of vinyl acetate and N-vinylpyrrolidone. An example of suitable commercially available polyvinyl acetates is Kollicoat® SR 30D or Kollidon® SR.

Other suitable polymers that are sparingly soluble include, but are not limited to, alkylcelluloses, e.g. ethylcellulose, and neutral cellulose esters, e.g. cellulose acetate butyrate.

It is also possible to use anionic polymers that are sparingly soluble. In some embodiments, the anionic polymers have at least about 5%, or in the range of 5 to 75%, of monomer moieties having anionic groups. In specific embodiments, the anionic polymer is anionic (meth)acrylate copolymers.

Examples of suitable commercially available (meth)acrylate copolymers having anionic groups are Eudragit® L, L 100-55, S, and FS.

Examples of suitable anionic (meth)acrylate copolymers include, but are not limited to, polymers made of from about 25 to about 95% by weight of C1-C4-alkyl esters of acrylic or methacrylic acid and from about 5 to about 75% by weight of (meth)acrylate monomers having an anionic group. As a function of the content of anionic groups and of the character of the other monomers, polymers of this type are generally water-soluble at pH values above about 5.0, and are therefore also soluble in intestinal fluid. The proportions mentioned generally give a total of 100% by weight.

A (meth)acrylate monomer having an anionic group can by way of example be acrylic acid or methacrylic acid. Other suitable materials include, but are not limited to, anionic (meth)acrylate copolymers made of from about 40 to about 60% by weight of methacrylic acid and from about 60 to about 40% by weight of methyl methacrylate, or from about 60 to about 40% by weight of ethyl acrylate. (Eudragit L or Eudragit L 100-55). EUDRAGIT L is a copolymer made of 50% by weight of methyl methacrylate and 50% by weight of methacrylic acid.

Eudragit L 100-55 is a copolymer made of 50% by weight of ethyl acrylate and 50% by weight of methacrylic acid. Eudragit L 30D-55 is a dispersion comprising 30% by weight of Eudragit L 100-55.

Materials that are likewise suitable include, but are not limited to, anionic (meth)acrylate copolymers made of from about 20 to about 40% by weight of methacrylic acid and from about 80 to about 60% by weight of methyl methacrylate (Eudragit® S). Examples of other suitable materials are (meth)acrylate copolymers composed of from about 10 to about 30% by weight of methyl methacrylate, from about 50 to about 70% by weight of methyl acrylate, and from about 5 to about 15% by weight of methacrylic acid (Eudragit® FS).

Eudragit FS is a copolymer made of 25% by weight of methyl methacrylate, 65% by weight of methyl acrylate, and 10% by weight of methacrylic acid. Eudragit FS 30 D is a dispersion comprising 30% by weight of Eudragit® FS. The copolymers of some embodiments, comprise or consist essentially to exclusively of, the monomers methacrylic acid, methyl acrylate, and ethyl acrylate, in the quantitative proportions stated above.

However, the material can also comprise small amounts in the range from 0 to 10% by weight, e.g. from 1 to 5% by weight, of other vinylically copolymerizable monomers, e.g. methyl methacrylate, butyl methacrylate, butyl acrylate, or hydroxyethyl methacrylate, without any resultant impairment of essential properties.

Partial esters of cellulose or of hydroxyalkylated cellulose with polyfunctional acids, such as succinic acid, phthalic acid, trimellitic acid, examples being cellulose acetate phthalate, cellulose acetate succinate, cellulose acetate trimellitate, hydroxypropylcellulose acetate succinate, hydroxypropylcellulose acetate phthalate,

Basic polymers that are sparingly soluble. It is also possible to use basic polymers, such as basic meth(acrylates) or chitosan. One example of a corresponding commercially available polymer is Eudragit® E or EPO, which is a copolymer made of methyl methacrylate, butyl methacrylate, and dimethylaminoethyl methacrylate.

It is also possible to use thermoplastic sugar alcohols, e.g. isomalt (available commercially as Palatinit®).

In detailed embodiments, mixtures made of water-soluble and non-water-soluble polymers are suitable. By way of example, mixtures made of copovidone and Kollidon® SR (BASF SE) are suitable. Kollidon SR is a commercially available coprocessed mixture made of 80% by weight of polyvinyl acetate, 19% by weight of povidone (Kollidon 30), 0.8% by weight of sodium lauryl sulfate, and 0.2% by weight of silica.

Fluids with kinematic viscosity <20 mm²/s, measured at 40° C. to DIN 51562, are among suitable coolants. In principle, fluids within the range from about 0.1 mm²/sec to below about 20 mm²/sec, for example, are suitable. A factor that has to be taken into account here is that fluids in the range from about 0.1 mm²/sec to about 2 mm²/sec relatively easily form ignitable mixtures in air, because they have relatively high vapor pressure (low boiling point), and can only be handled with specific explosion-protection measures, but on the other hand can be removed very easily from the surface by evaporation.

In one or more embodiments, fluids with kinematic viscosity in the range from about 10 mm²/s to about 19 mm²/s, or from about 18 to about 11 mm²/s, or from about 17 to about 12 mm2/s, are used. This specific embodiment permits operation without any increased level of complicated explosion-protection measures.

During the pelletization process, the temperature of the coolant is controlled within the range of about 10 to about 90° C., or in the range of about 15 to about 80° C., or in the range of about 20 to about 50° C.

The range to be selected depends on the melting or softening points of the polymers and active-ingredient systems used. The temperature selected is generally sufficiently far below the softening/melting point of the system to permit clear-cut freezing on cooling. The bath temperature can be adjusted to temperatures in the region of about 50, about 70, or about 100° C. below the melting point. The person skilled in the art can easily determine and select the most suitable temperature for any particular case.

To carry out the process in accordance with one or more embodiments of the invention, the polymers, or a mixture made of polymers and of other components, is/are mixed to give a homogeneous melt. This can be achieved by way of example by introducing a physical premix of solid starting materials into a suitable extruder or kneader, melting the mixture with use of mechanical and thermal energy, and conveying the hot melt, while it remains plastic, through an orifice plate or a die plate, directly into the coolant. If the formulation also comprises liquid ingredients, it is advisable to add these separately by way of a metering pump. If thermally labile active ingredients are used, it can also be advisable to begin by producing a melt of the thermoplastically processible polymers and, if desired, of other formulation auxiliaries, and only then to add the active ingredient. In detailed embodiments, the melting process takes place in a screw-based machine, or in a twin-screw extruder, of corotating type. The process of some embodiments takes place in the absence of solvents. In the event that there is a requirement to add one or more of the starting materials in the form of a solution to the mixture, the solvents used here can be removed in the downstream extruder zones by simple evaporation, optionally with application of a vacuum. The extruded material, while it remains thermoplastic, does not then comprise any residual solvent.

As a function of the constitution of the mixture, the melting of the starting materials can take place at temperatures in the range of about 50 to about 300° C., or in the range of about 70 to about 250° C.

The plastic strands that emerge are comminuted by a cutting apparatus attached at the orifice plate or die plate, to give pellets. Suitable pelletizing apparatuses are commercially available apparatuses such as those used for underwater pelletization. The melt comprising polymer here is comminuted by a rotating knife within the knife chamber to give small droplets which are transported away by the fluid coolant and which freeze to give lenticular particles or spherical particles with varying degrees of roundness.

In some embodiments of the invention, said beads are separated and discharged from the coolant by means of a centrifuge. For successful separation by means of centrifuge, the density of the coolant is generally smaller than the density of the pellets comprising polymer. It is also advisable to adjust the mesh width of the centrifuge sieve so that it is appropriate to the viscosity of the coolant and to the desired grain size of the pellets. Preference is given to the maximum mesh size for the expected grain size, since otherwise separation is incomplete, with resultant disruption of the process. In detailed embodiments, the ratio of mesh width of the centrifuge sieve to average grain size in the range of about 0.1 to about 0.95. It is also possible to use centrifuges with slot-perforated metal sheets, where in that case the ratio selected is numerically the same but then relates to the size of the narrow side of the slot aperture.

In some embodiments, the means of separation can be a sieve and filter system rather than a centrifuge. Examples of equipment suitable for this purpose are filter bags made of appropriate permeable textiles, edge-split filters, metal-mesh filters, metal-mesh-composite sheets, or metal-mesh-composite tubes, where the finest filter layer faces toward the product. Said filtration can take place at atmospheric pressure, or superatmospheric pressure, or in vacuo.

A fluid coolant is used, and acts as non-solvent for the water-soluble components. Non-solvent here means a fluid which, during the time of contact with the water-soluble polymer or the water-soluble biologically active substance of the pellets, does not have any dissolving or incipient swelling action and does not cause caking. The times during which coolant and pellets are in contact are usually in the range of about 0.02 to about 2 minutes. Suitable fluids of this type are nonpolar fluids, such as linear and branched saturated and to some extent unsaturated hydrocarbons, mineral-oil fractions, long-chain alcohols and fatty acids, and also natural vegetable oils, such as palm oil, sunflower oil, olive oil, and the like. Silicone oil can also be used for certain applications. The selection of the nonsolvent depends on the polymers to be pelletized and on the requirements placed upon the pellets (use in the food sector or industrial processing, ease of removal of the fluid residues, and the like). The fluids mentioned here are merely examples and have no restricting effect. As mentioned above, the kinematic viscosity of fluids suitable as coolant from the present invention is smaller than 20 mm²/sec at 40° C.

In one or more embodiments, the fluid coolants are conducted in a circuit. The fluid circuit may be cooled in order to avoid excessive heating to relatively high temperatures, for example, the softening points of the pelletized substance system, or temperatures above the glass transition temperature of the polymers. The temperature of the coolant in some embodiment is kept at temperatures which are at least 50° C. below the melting point.

The pellets thus produced can still comprise small amounts of the fluid, for example of the orders of magnitude of from 0.01 to 5% by weight, based on the total weight of the pellets, where the adherent amount depends on the grain size of the pellets, on the properties of the coolant, and on the process parameters set within the pelletizing apparatus. The adherent coolant usually still has to be removed, to the extent that low boiling point does not cause its spontaneous evaporation.

This can be achieved mechanically, for example by means of absorbent media, such as felt, cellulose, cotton textiles or other textiles, or through washing, for example with a low-boiling-point hydrocarbon which is a good solvent for the coolant and itself evaporates rapidly, but without any solvation of, or incipient swelling of, the pellets.

The process of one or more embodiments of the invention can produce the pellets with very uniform shape and size. In some embodiments, the pellets have average particle sizes (Q50%) in the range of about 0.05 to about 10 mm, or in the range of about 0.1 to about 5 mm, or in the range of about 0.2 to about 3 mm. The particle size distribution is analyzed in the form of cumulative distribution: Q10% means that 10% of the particles are smaller than the stated value, Q50% means that 50% are smaller than the stated value, and Q90% means that 90% are smaller than the stated value.

The particle sizes can be determined by sieve analysis, as stated in the European Pharmacopoeia. Optical methods (Camsizer) can also be used.

Formulations of this type can comprise not only polymers and biologically active substances but also conventional additions used in extrusion technology and relevant for formulation purposes, examples being copolymers, plasticizers, surfactants, stabilizers, colorants, such as inorganic or organic pigments, flavors and sweeteners, and lubricants or release agents.

Non-limiting examples of plasticizers that can be used are polyethylene glycols, triacetin, triethyl citrate, or propanediol. To the extent that plasticizers are used, the amount of these depends on the overall behavior of the starting materials. The amount of plasticizer is adjusted in such a way that the melt is extrudable and pelletizable. The amounts can vary with the character of the starting materials.

Non-limiting examples of suitable stabilizers are antioxidants or preservatives.

Suitable surfactants, include but are not limited to, surfactant substances with HLB (HydrophilicLipophilicBalance) value in the range of about 1 to about 40 (cf. Fiedler, Lexikon der Hilfsstoffe [Encyclopedia of Auxiliaries], vol. 1, pages 77-82, 4th edition, Editio Cantor, Aulendorf), for example hydrogenated castor oil (Cremophor® RH 40), ethoxylated by 40 ethylene oxide units, or castor oil (Cremophor EL) ethoxylated by 35 ethylene oxide units, polysorbate 80, poloxamers, docusate sodium, or sodium lauryl sulfate.

As a function of application sector and processibility, the proportions of active ingredient, polymer, and of additives can vary widely. The only restricting conditions are the thermoplastic processibility and the solubility properties described for the formulation. Active ingredient content will generally be in the range from about 5 to about 90% by weight, or in the range of about 5 to about 80% by weight, or in the range of about 5 to about 60% by weight. The remainder is formed by polymers, generally amounting to from about 10 to about 55% by weight, and also by formulation auxiliaries.

The process of various embodiments is suitable for the production of pellets based on thermoplastically processible polymers, and for the production of pellets comprising biologically active substances, and in which one or more biologically active substances are present in homogeneous dispersion in a matrix based on thermoplastically processible polymers.

Biologically active substances that can be used are in general any of the substances which are intended to be released within the gastrointestinal tract of humans and animals. Non-limiting examples of suitable pharmaceutical active ingredients, vitamins, vitaminoids, carotenoids, enzymes, hormones, amino acids or what are known as “nutraceuticals”, i.e. food supplements and dietetic agents.

It is also possible to use the method described above in formulating active ingredients for plant protection, detergent ingredients, such as enzymes, fragrances and flavors, or other active substances.

One or more embodiments of the invention are suitable for the production of particulate preparations of biological substances. Biologically active substances are substances which bring about a biological effect in living organisms.

Some embodiments are suitable, by way of example, for formulating the following substances or physiologically acceptable salts thereof, where the salts can also be produced in situ within the extruder.

The pharmaceutical active ingredients of various embodiments include, but are not limited to, substances which are insoluble or sparingly soluble, or have little solubility, or are soluble in water. DAB 9 (Deutsches Arzneimittelbuch [German Pharmacopoeia]) classifies the solubility of pharmaceutical active ingredients as follows: (where in each case 1 part of the substance is soluble in the respective amounts mentioned of water) very readily soluble (soluble in 1 part of solvent), readily soluble (soluble in from 1 to 10 parts of solvent), soluble (soluble in from 10 to 30 parts of solvent), low solubility (soluble in from 30 to 100 parts of solvent); sparingly soluble (soluble in from 100 to 1000 parts of solvent); practically insoluble (soluble in more than 10 000 parts of solvent). These active ingredients can derive from any field of indications.

One or more embodiments of the invention are suitable for biologically active substances which have good solubility in water. As used in this specification and the appended claims, this means that, in terms of the definition given above, they are very readily soluble, readily soluble, or soluble. Follows is a non-limiting list of biologically active substances and categories which are suitable for use with embodiments of the invention.

—Antiinfective Compositions

aciclovir, aminoglycosides, amphotericin B, azole antimycotics, clotrimazole, itraconazole, sepraconazole, clindamycin, cephalosporins, chloramphenicol, erythromycin, 5-fluorouracil, etoposide, fluctytosine, ganciclovir, griseofulvin, gyrase inhibitors, isoniazid, lincosamides, mebendazole, mefloquine, metronidazole, nitroimidazoles, novobiocin, platinum compounds, polymyxin B, praziquantel, pyrimethamine, rifamipicin, saquinavir, streptomycin, sulfonamides, tetracyclines, trimethoprim, vancomycin, zidovudine;

—Antipyretics, analgesics, anti inflammatories, paracetamol, ibuprofen, ketoprofen, oxaprozin, acetylsalicylic acid, morphine, oxaprozin, propoxyphene, phenylbutazone;

—Antibiotics

rifampicin, griseofulvin, chloramphenicol, cycloserine, erythromycin, penicillins such as penicillin G, streptomycin, tetracycline;

—Antiepileptics

hydantoins, carbamazepine;

—Antitussives and Antiasthmatics

diphenhydramine;

—Antirheumatics

chloroquin, indomethacin, gold compounds, phenylbutazone, oxyphenylbutazone, pencillinamine;

—Hypnotics

barbiturates, phenobarbital, zolpidem, dioxopiperidines, ureides;

—Insecticides

aldrin, dieldrin, chlorphenotane, hexachlorocyclohexane;

—Herbicides

vinclozolin, strobilurins;

—Antipsychotics, Neuroleptics

perazine, promazine, sulpiride, thioridazine, chlorpromazine, meprobamate, triflupromazine, melperone, clozapine, risperdione, reserpine;

—Tranquillizers;

—Antidepressives

imipramine, paroxetine, viloxazine, moclobemide;

—Psychotonics;

—Psychomimetics;

—Diuretics

potassium canrenoate, loop diuretics, furosemide, hydrochlorothiazide, spironolactone, thiazides, triamterene;

—Hormones

androgens, antiandrogens, gestagens, glucocorticoids, estrogens, cortisol, dexamethasone, prednisolone, testosterone, adiuretin, oxytocin, somatropin, insulin;

—Immunosuppressants

ciclosporin;

—Bronchodilators;

—Muscle Relaxants, Tranquillizers

carisoprodol, tetrazepam, diazepam, chlordiazepoxide;

—Enzymes

lipase, phytase;

—Antigouts

allopurinol, colchicine;

—Anticoagulants

coumarins;

—Antiepileptics

phenotoin, phenobarbital, primidone, valproic acid, carbamazepine;

—Antihistamines

chlorphenoxamine, dimenhyrinate;

—Antiemetics;

—Antihypertensives, Antiarrhythmics

lidocaine, procainamide, quinidine, calcium antagonists, glycerol trinitrate, isosorbide dinitrate, isosorbide 5-mononitrate, pentaerythrityl tetranitrate, nifedipine, diltiazem, felodipine, verapamil, reserpine, minoxidil, captopril, enlanapril, lisinopril;

—Sympathomimetics

norfenefrine, oxedrine, midodrine, phenylephrine, isoprenaline, salbutamol, clenbutorol, ephedrine, tyramine, β-blockers such as alprenolol, metoprolol, bisoprolol;

—Antidiabetics

biguanides, sulfonylureas, carbutamide, tolbutamide, glibenclamide, metformin, acarbose, troglitazone;

—Iron Preparations;

—Vitamins and Vitaminoids

For example, ascorbic acid, tocopherol, tocopherol acetate, vitamin A and vitamin A derivatives, vitamin K and vitamin K derivatives or vitamin D and vitamin D derivatives, riboflavin, vitamin B₁₂, nicotinic acid, nicotinamide, pyridoxin hydrochloride, biotin, folic acid, folic acid derivatives, such as tetrahydrofolic acid, 5-methyltetrahydrofolic acid, 10-formyltetrahydrofolic acid or 5-formyltetrahydrofolic acid;

carotenoids, for example β-carotene, lycopene, lutein, astaxanthin or zeaxanthin;

polyunsaturated fatty acids, for example linoleic acid, linolenic acid, arachidonic acid, docohexaenoic acid or eicosapentaenoic acid;

compounds having vitamin character or coenzyme character, for example carnitine, choline chloride, taurine, creatine, ubichinones, S-methylmethionine or S-adenosylmethionine;

—ACE Inhibitors

captopril, ramipril, enalapril;

—Anabolics;

—Iodine Compounds;

—X-Ray Contrast Materials;

—Compounds Having CNS Activity;

—Antiparkinsonians

biperiden, benzatropine, amantadine, opioid analgesics, barbiturates, bezodiazepines, disulfuram, lithium salts, theophylline, valproinate, neuroleptics;

—Cytostatics;

—Antispasmolytics;

Vasodilators

naftidrofuryl, pentoxifylline.

Other biologically active substances that can be used include, but are not limited to, active ingredients such as those used in traditional Chinese medicine.

The process in accordance with one or more embodiments permits production, via melt extrusion and pelletization, of formulations which comprise active ingredients and which have a particularly uniform shape and low dust content. Surprisingly, it is also possible to process formulations which comprise water-insoluble components, without solvation of these within the coolant.

The release curves show that it is possible to achieve risk-free and reliable control of the release rate by way of particle size with the aid of the process of one or more embodiments of the invention.

The pellets some embodiments are particularly suitable, for example, for use in the production of pharmaceutical products for the human sector and veterinary sector, and also for plant-protection compositions, feed compositions, food supplements, or dietetic agents.

The pellets are likewise suitable, for example, for detergent formulations which comprise fragrances or enzymes as biologically active substances.

The pellets can be used as they stand. They are also suitable in the form of capsule fillings, for the production of drinks granules, or for pressing to give tablets.

### EXAMPLES

### Starting Materials

Soluplus®, BASF SE: graft polymer made of PEG 6000/N-vinylcaprolactam/vinyl acetate, average molar mass determined by gel permeation chromatography: from 90,000 to 140,000 g/mol.

Kollidon® VA 64, BASF SE, a copolymer made of N-vinylpyrrolidone and vinyl acetate in a ratio of 60:40 by weight, termed “copovidone” in Pharmacopoeias.

Kollidon® SR: coprocessed mixture made of polyvinyl acetate, polyvinylpyrrolidone K30 (povidone in European or US Pharmacopoeias), sodium lauryl sulfate, and silica in a ratio of 80/19/0.8/0.2 by weight.

PEG 1500: Polyethylene glycol, molar mass 1500 g/mol

PEG 6000: Polyethylene glycol, molar mass 6000 g/mol

General Preparation Specification:

Apparatus

A ZSK 25 (Werner & Pfleiderer) corotating twin-screw extruder was used to melt the polymer to be processed. The extruder had a metering apparatus, a melt pump, a diverter valve, and an underwater pelletization apparatus (GALA-LPU, Gala, Xanten), and it also had a heated pelletizing die with hole diameter of 3.2 mm. Knife: quintuple-cutting, rotation rate from 800 to 2000 rpm. A centrifuge (grid: 1.9 mm, rotation rate 1500 rpm) was used for the separation process.

W118 white oil (Fuchs Petrolub), viscosity 16 mm2/s at 40° C., measured to DIN 51562, was used as coolant in examples 1 to 7.

Table 1 shows the constitution of the pellets from Examples 1 to 7. The percentages are based on percent by weight.

TABLE 1

| | Ex. 1 | Ex. 2 | Ex. 3 | Ex. 4 | Ex. 5 | Ex. 6 | Ex. 7 |
|---|---|---|---|---|---|---|---|
| Soluplus | 100% | 90% | | | | | |
| Kollidon VA 64 | | | 95% | 90% | | 60% | 30% |
| Kollidon SR | | | | | 90% | 40% | 20% |
| PEG 1500 | | 10% | | | | | |
| PEG 6000 | | | 5% | 10% | 10% | | |
| Theophylline | | | | | | | 50% |

In all cases, it was possible to produce uniformly shaped bead pellets which could easily be isolated from the coolant. Table 2 shows a list of the average particle size of selected compositions.

TABLE 2

| | | Knife | | | | |
|---|---|---|---|---|---|---|
| Ex. | Extruder | rotation | X [μm] | X [μm] | X [μm] | |
| No. | throughput | rate [rpm] | Q3 = 10% | Q3 = 50% | Q3 = 90% | Span |
| 1 | 5 kg/h | 1300 | 2536 | 2875 | 3138 | 0.21 |
| 2 | 5 kg/h | 1300 | 2626 | 2913 | 3355 | 0.25 |
| 4 | 5 kg/h | 1300 | 2327 | 2682 | 4124 | 0.67 |
| 6 | 5.5 kg/h | 800 | 3585 | 4109 | 4416 | 0.202 |
| 7 | 5.5 kg/h | 2000 | 2663 | 3011 | 3317 | 0.217 |

Average particle size was determined by a Camsizer.

The FIGURE depicts a comparison of the release from pure theophylline with the release from pellets of Ex. 6 (diameter 3011 μm), and Ex. 7 (diameter 4109 μm). The release curves provide evidence of the effect of pellet particle size on release.

### Comparative Example

Processing was based on inventive example 1. However, a relatively high-viscosity white oil (Winol® W20) was used, with viscosity 20 mm2/s at 40° C. Pellet beads caked within the pelletization apparatus and within the centrifuge sieve. It was not possible to achieve complete pellet/coolant separation.

What is claimed is:

1. A process for producing pellets based on at least one thermoplastically processible polymer, where the pellets comprise at least one water-soluble component, the process comprising melt-extruding the pellet and shaping the pellet in a coolant, which is a non-solvent for the polymer, where the kinematic viscosity of the coolant is <20 mm²/s, measured at 40° C.

2. The process according to claim 1, wherein the kinematic viscosity of the coolant is in the range of about 10 to about 19 mm²/s, measured at 40° C.

3. The process according to claim 1, wherein the kinematic viscosity of the coolant is in the range of about 11 to about 18 mm²/s, measured at 40° C.

4. The process according to claim 1, wherein the kinematic viscosity of the coolant is in the range of about 12 to about 17 mm²/s, measured at 40° C.

5. The process according to claim 1, wherein the coolant comprises a hydrocarbon.

6. The process according to claim 1, wherein the coolant comprises a white oil.

7. The process according to claim 1, wherein the coolant is temperature-controlled.

8. The process according to claim 1, wherein the coolant has a temperature of at least 50° C. below a temperature of the extruded melt.

9. The process according to claim 1, wherein the pellets are isolated from the coolant by centrifuging.

10. The process according to claim 1, wherein the pellets are isolated from the coolant by filtering.

11. The process according to claim 1, wherein the melt extrusion process is carried out at melt temperatures in the range of about 50 to about 300° C.

12. The process according to claim 1, wherein the water-soluble component comprises a water-soluble thermoplastically processible polymer.

13. The process according to claim 1, wherein the water-soluble component comprises a water-soluble biologically active substance.

14. The process according to claim 1, wherein the water-soluble component comprises homo- or copolymers of N-vinyllactams.

15. The process according to claim 1, wherein the water-soluble component comprises graft copolymers based on polyethers.

16. The process according to claim 15, wherein the graft copolymer comprise polyether units as graft base and polyvinyl alcohol units as side chains.

17. The process according to claim 15, wherein the graft copolymers comprise polyether units as a graft base and side chains obtained from N-vinylcaprolactam and N-vinyl acetate.

18. The process according to claim 1, wherein the water-soluble component comprises polyvinyl acetate.

19. The process according to claim 1, wherein the pellet comprises a coprocessed mixture comprising polyvinyl acetate and polyvinylpyrrolidone.

20. A method for producing a dosage form comprising using the pellet of claim 1 and a biologically active substance.
